(19) United States
(12) Patent Application Publication
(10) Pub. No.: US 2008/0041968 A1
(43) Pub. Date: Feb. 21, 2008

(54) MOBILE PHONE AND DATA STORAGE CARD HOLDER THEREOF

(75) Inventors: Jiming Chen, Suzhou (CN); Tao Liu, Suzhou (CN)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/835,404

(22) Filed: Aug. 7, 2007

(30) Foreign Application Priority Data
Aug. 17, 2006 (TW) TW95130213

(51) Int. Cl. G06K 21/06

(52) U.S. Cl. 235/495

(57) ABSTRACT

A holder for a data storage card in a predetermined position of a mobile phone includes a main body, a joining portion disposed at one end of the main body and joined to the mobile phone, a clamping portion disposed on the main body and clamping the data storage card, and a flexible portion disposed on the main body and positioned between the joining portion and the clamping portion. When the flexible portion is bent, the clamping portion moves the data storage card from the predetermined position, and the flexible portion is further bent to release the data storage card from the clamping portion.

### BACKGROUND OF THE INVENTION

1. Field of the Invention

The invention relates to a holder for a data storage card in a mobile phone, and in particular relates to a holder for a subscriber identity module card (SIM card) in a mobile phone.

2. Description of the Related Art

Mobile phones are provided with certain data storage cards, such as a SIM card or a Security Digital card. The holder for the data storage card is important for the stability and function of the mobile phone.

U.S. Pat. No. 6,035,216 discloses a holder for a data storage card as shown in FIGS. 1a, 1b and 1c. A slot 21 is formed on a corner 203 connecting a top 201 and a lateral side 202. A rectangular tray 23 is rotatably disposed in the slot 21. An accommodation portion 233 is formed on the tray 23 to accommodate data storage card 300. The tray 23 can rotate to enter the slot 21 and be positioned by an engaging element 22 engaging a notch 236 on the tray 23 as shown in FIG. 1a. When the engaging element 22 is pushed, the tray 23 springs out as shown in FIG. 1b. The tray 23 is further rotated to reveal the accommodating portion 233, whereby the data storage card 300 is placed into the accommodating portion 233 as shown in FIG. 1c.

The structure of the holder disclosed by the patent U.S. Pat. No. 6,035,216 is too complicated, which increases cost.

### BRIEF SUMMARY OF INVENTION

An embodiment of a holder for a data storage card in a predetermined position of a mobile phone comprises a main body, a joining portion disposed at one end of the main body and joined to the mobile phone, a clamping portion disposed on the main body and clamping the data storage card, and a flexible portion disposed on the main body and positioned between the joining portion and the clamping portion. When the flexible portion is bent, the clamping portion moves the data storage card from the predetermined position, and the flexible portion is further bent to release the data storage card from the clamping portion.

The holder further comprises a pulling portion disposed at the other end of the main body. When the pulling portion is pulled, the flexible portion is bent to move the clamping portion.

When the data storage card is positioned in the predetermined position, the clamping portion clamps the data storage card and engages the mobile phone.

The joining portion is rotatably joined to the mobile phone. After the data storage card is released from the clamping portion, the joining portion rotates to allow the data storage card to be removed from the mobile phone. The joining portion comprises a first tapered portion, a second tapered portion and a cylindrical portion disposed between the first and second tapered portions and connecting the first and second tapered portions. The diameter of the cylindrical portion exceeds that of a hole formed on the mobile phone, whereby the joining portion is joined to the mobile phone. The first tapered portion has one end connected to the main body and the other end connected to the cylindrical portion. The diameter of the first tapered portion gradually increases from the main body to the cylindrical portion and the diameter of the end of the first tapered portion connected to the main body is less than that of the hole. The second tapered portion has one end connected to the cylindrical portion and a free end. The diameter of the second tapered portion gradually decreases from the cylindrical portion to the free end.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIGS. 1a, 1b and 1c are schematic views of a conventional card holder of a mobile phone;

FIG. 2 is a perspective view of one mobile phone according to the invention;

FIG. 3 is a bottom view of the mobile phone shown in FIG. 2;

FIG. 4 is a cross section along the line A-A shown in FIG. 3;

FIG. 5 is a perspective view of one holder according to the invention;

FIG. 6 is a top view of the holder shown in FIG. 5;

FIG. 7 is a schematic view of an joining portion of the holder shown in FIG. 5;

FIG. 8 is a cross section along the line B-B shown in FIG. 6;

FIG. 9 is a schematic view of another embodiment of the holder shown in FIG. 8; and

FIGS. 10-12 depict the motion of the holder according to the invention.

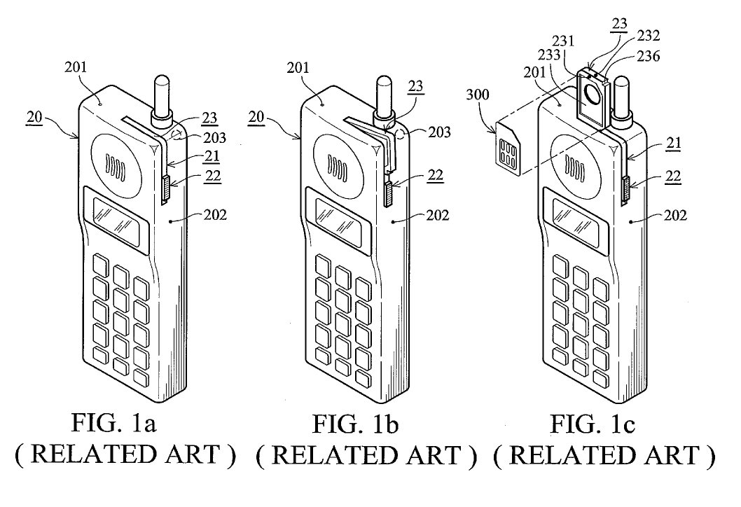

### DETAILED DESCRIPTION OF INVENTION

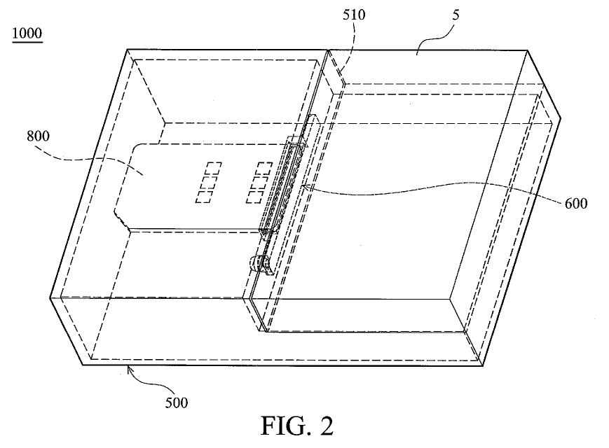

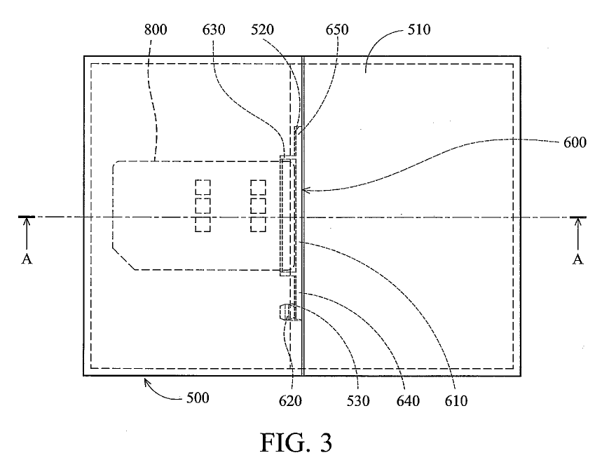

Referring to FIGS. 2 and 3, a mobile phone 1000 according to the invention comprises a housing 500 and a holder 600. A data storage card 800 is clamped and positioned by the holder 600. The housing 500 has a battery bay 510, an engaging groove 520 and a hole 530 as shown in FIG. 3. The battery bay 510 accommodates a battery 5. The holder 600 engages the engaging groove 520 which is connected to the battery bay 510. The hole 530 is joined to a joining portion 620 of the holder 600.

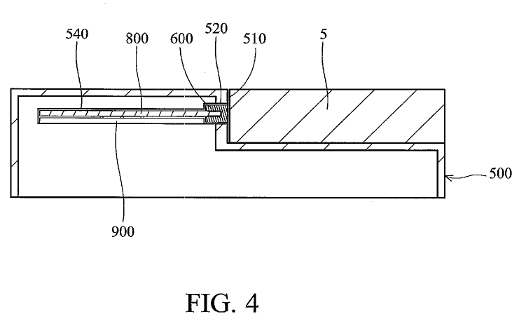

Referring to FIGS. 3 and 4, the data storage card 800 is first positioned in an accommodating position, such as an accommodating groove 540 shown in FIG. 4, to maintain electrical connection with a circuit board 900 in the mobile phone 1000. The holder 600 clamps the data storage card 800 and engages the engaging groove 520, whereby the data storage card 800 is positioned in the accommodating groove 540.

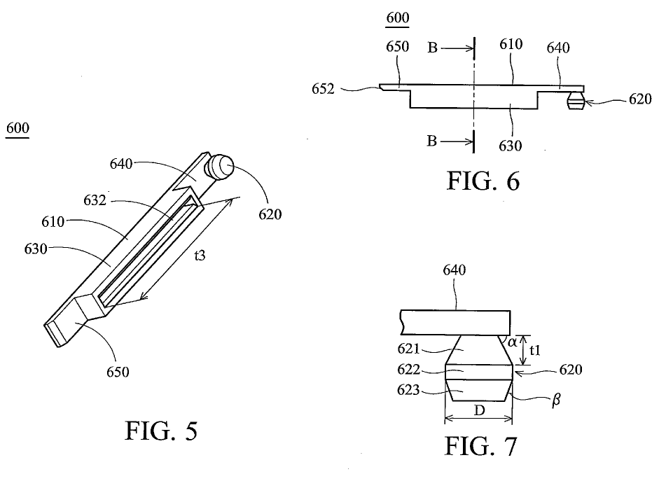

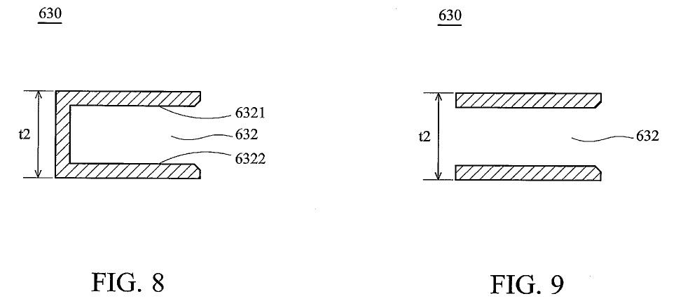

Referring to FIGS. 5 and 6, the holder 600 comprises a main body 610, a joining portion 620, a clamping portion 630, a flexible portion 640 and a pulling portion 650. The main body 610 is a strip. The joining portion 620 is disposed at one end of the man body 610. The clamping portion 630 is disposed on the main body 610 to clamp the data storage card 800. The flexible portion 640 is formed on the main body 610 and disposed between the joining portion 620 and the clamping portion 630. In this embodiment, the flexible portion 640 is a part of the main body 610. The flexible portion 640 is of appropriately malleable material to allow the required deformation. The pulling portion 650 is disposed at the other end of the main body 610. When the data storage card 800 is positioned in the accommodating groove 540, the joining portion 620 enters the hole 530, and the main body 610 and the clamping portion 630 engage the engaging groove 520. When the data storage card 800 is to be removed, the pulling portion 650 is pulled (a guide portion 652 is formed on the tip of the pulling portion 650 for easy pulling). As the joining portion 620 enters the hole 530, the flexible portion 640 bends to move the clamping portion 630, whereby the data storage card 800 is moved and a part of the data storage card 800 is exposed. The data storage card 800 can thus be withdrawn from the accommodating groove 540.

Referring to FIG. 7, the joining portion 620 comprises a first tapered portion 621, a cylindrical portion 622 and a second tapered portion 623. The cylindrical portion 622 is positioned between the first tapered portion 621 and the second tapered portion 623 and connects the first and second tapered portions 621 and 623. The first tapered portion 621 has one end connected to the main body 610, and the other end connected to the cylindrical portion 622. The diameter of the first tapered portion 621 increases gradually from the main body 610 to the cylindrical portion 622. The angle a between the lateral surface of the first tapered portion 621 and the main body 610 is less than 90°. The second tapered portion 623 has one end connected to the cylindrical portion 622 with the other end free. The diameter of the second tapered portion 623 decreases from the cylindrical portion 622 to the free end. The angle β between the lateral surface of the second tapered portion 623 and the cylindrical portion 622 exceeds 0°. The length t1 of the lateral surface exceeds the wall thickness of the hole 530 to ensure that cylindrical portion 622 enters the hole 530 completely. The diameter D of the cylindrical portion 622 exceeds the diameter of the hole 530 to prevent the cylindrical portion 622 from escaping therefrom. In another embodiment, the cylindrical portion 622 can be omitted. Only the first and second tapered portions 621 and 623 constitute the joining portion 620 which can also be joined to the hole 530.

Referring to FIGS. 5 and 6, in the embodiment, the clamping portion 630 is rectangular and disposed on the main body 610. A long clamping groove 632 is formed on the clamping portion 630 to clamp the data storage card 800. The width t2 of the clamping groove 632 is less than the thickness of the data storage card 800, whereby the data storage card 800 is tightly fitted into the clamping groove 632. In another embodiment, the length t3 of the clamping groove 632 is less than the length of the data storage card 800, whereby the data storage card 800 is tightly fitted into the clamping groove 632. In addition, as the clamping portion 630 clamps the data storage card 800 and engages the engaging groove 520, the clamping portion 630 is preferably made of malleable material. In addition, as the data storage card 800 is clamped by the lateral walls 6321 and 6322 of the clamping groove 632, bottom of the clamping groove 632 can be neglected, as shown in FIG. 9. In such a structure, more space can be provided for accommodation of the data storage card. The data storage card 800 can even be exposed out of the holder, allowing it to be clamped more tightly.

The holder, comprising the main body, the joining portion, the clamping portion and the flexible portion can be formed by Sandwich Injection Molding.

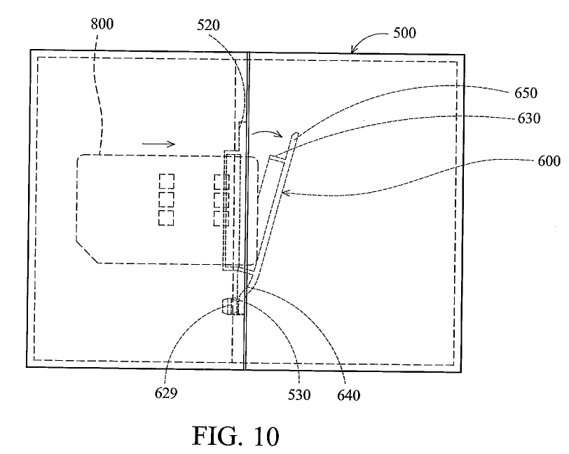

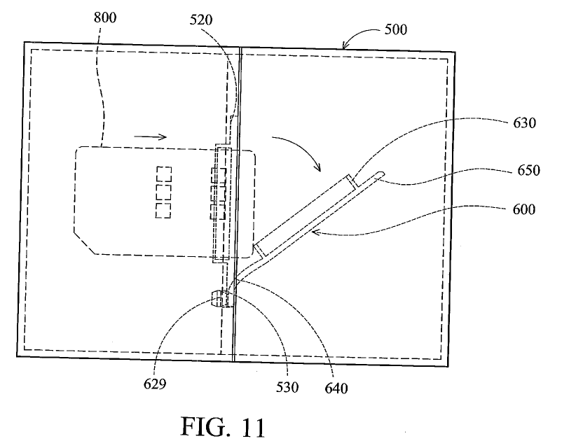

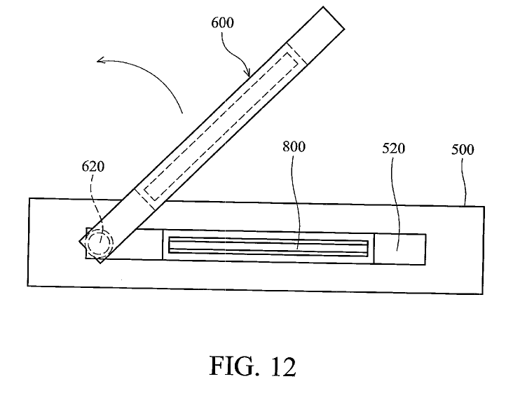

Referring to FIG. 3 again, when the data storage card is accommodated in the accommodating position, the clamping portion 630 clamps the data storage card 800, the holder 600 engages the engaging groove 520, and the joining portion 620 enters the hole 530. When the data storage card 800 is to be removed, the pulling portion 650 is pulled to bend the flexible portion 640 and move the clamping portion 630, whereby the data storage card 800 is moved and a part of the data storage card 800 is exposed as shown in FIG. 10. The flexible portion 630 bends further to release the data storage card 800 as shown in FIG. 11. As the hole 530 can only constrain the joining portion 620 without fixing it, the holder 600 can rotate about the joining portion 620 to prevent obstruction of the data storage card 800 as shown in FIG. 12.

When the data storage card 800 is to be installed in the mobile phone 1000, the data storage card 800 is inserted into the accommodating groove 540 with a part exposed. The clamping portion 630 clamps the exposed part of the data storage card 800, and the entire holder 600 with the data storage card 800 is pushed into the accommodating groove 540 to engage the holder 600 with the engaging groove 520 and the data storage card 800 electrically contacting the circuit board 900.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A holder for a data storage card in a predetermined position of a mobile phone, comprising:
a main body;
a joining portion disposed at one end of the main body and joined to the mobile phone;
a clamping portion disposed on the main body and clamping the data storage card;
a flexible portion disposed on the main body and positioned between the joining portion and the clamping portion, wherein when the flexible portion is bent, the clamping portion moves the data storage card from the predetermined position, and the flexible portion is further bent to release the data storage card from the clamping portion.

2. The holder as claimed in claim 1 further comprising a pulling portion disposed at the other end of the main body, wherein when the pulling portion is pulled, the flexible portion is bent to move the clamping portion.

3. The holder as claimed in claim 1, wherein when the data storage card is positioned in the predetermined position, the clamping portion clamps the data storage card and engages the mobile phone.

4. The holder as claimed in claim 1, wherein the joining portion is rotatably joined to the mobile phone, and after the data storage card is released from the clamping portion, the joining portion rotates to allow the data storage card to be removed from the mobile phone.

5. The holder as claimed in claim 4, wherein the joining portion comprises a first tapered portion, a second tapered portion and a cylindrical portion disposed between the first and second tapered portions and connecting the first and second tapered portions, and the diameter of the cylindrical portion exceeds that of a hole formed on the mobile phone, whereby the joining portion is joined to the mobile phone.

6. The holder as claimed in claim 5, wherein the first tapered portion has one end connected to the main body and the other end connected to the cylindrical portion, and the diameter of the first tapered portion gradually increases from the main body to the cylindrical portion and the diameter of the end of the first tapered portion connected to the main body is less than that of the hole, and the second tapered portion has one end connected to the cylindrical portion and a free end, wherein the diameter of the second tapered portion gradually decreases from the cylindrical portion to the free end.

7. The holder as claimed in claim 1, wherein the clamping portion is substantially rectangular and has a clamping groove clamping the data storage card.

8. The holder as claimed in claim 7, wherein the width of the clamping groove is slightly less than the thickness of the data storage card, whereby the data storage card is tightly fitted into the clamping groove.

9. The holder as claimed in claim 7, wherein the length of the clamping groove is slightly less than the length of the data storage card, whereby the data storage card is tightly fitted into the clamping groove.

10. The holder as claimed in claim 7, wherein the clamping groove has no bottom.

11. The holder as claimed in claim 1, wherein the clamping portion comprises malleable material.

12. The holder as claimed in claim 1, wherein the flexible portion comprises malleable material.

13. The holder as claimed in claim 1, wherein the main body is a strip.

14. A mobile phone, comprising:
a housing having an accommodating position accommodating a data storage card; and
a holder comprising:
a main body;
a joining portion disposed at one end of the main body and joined to the mobile phone;
a clamping portion disposed on the main body and clamping the data storage card;
a flexible portion disposed on the main body and positioned between the joining portion and the clamping portion, wherein when the flexible portion is bent, the clamping portion moves the data storage card from the accommodating position, and the flexible portion is further bent to release the data storage card from the clamping portion.

15. The mobile phone as claimed in claim 14, wherein the holder further comprises a pulling portion disposed at the other end of the main body, wherein when the pulling portion is pulled, the flexible portion is bent to move the clamping portion.

16. The mobile phone as claimed in claim 14, wherein when the data storage card is positioned in the accommodating position, the clamping portion clamps the data storage card and engages the mobile phone.

17. The mobile phone as claimed in claim 16, wherein the clamping portion is substantially rectangular and has a clamping groove clamping the data storage card.

18. The mobile phone as claimed in claim 17, wherein the housing has an engaging groove adjacent to the accommodating position, and when the data storage card is positioned in the accommodating position, the clamping portion engages the engaging groove.

19. The mobile phone as claimed in claim 14, wherein the data storage card is a subscriber identity module card.

20. A mobile phone, comprising:
a housing having a predetermined position accommodating a data storage card; and
a holder according to claim 1.
